(19) United States
(12) Patent Application Publication
(10) Pub. No.: US 2010/0314811 A1
(43) Pub. Date: Dec. 16, 2010

(54) Method For Improving The Stability Against Vibrations Of A Stay Cable

(75) Inventors: Erik Mellier, Asnieres Sur Seine (FR); Benoit Lecinq, Middle Cove (AU)

Correspondence Address: MCKENNA LONG & ALDRIDGE LLP, 1900 K STREET, NW, WASHINGTON, DC, 20006, US

(73) Assignee: SOLETANCHE FREYSSINET, Rueil-Malmaison (FR)

(21) Appl. No.: 12/742,621

(22) PCT Filed: Nov. 12, 2007
(86) PCT No.: PCT/IB2007/055385

§ 371 Date: Aug. 24, 2010

(51) Int. Cl. F16F 7/14; F16F 7/00

(52) U.S. Cl. 267/140.4; 267/136

(57) ABSTRACT

The invention proposes a method for improving the stability against vibrations of a stay cable (12) comprising at least one strand (11) housed in a substantially externally smooth sheath (1). In this method, at least one wire (2-3) is spirally wound round the sheath so as to be substantially in contact with said sheath along at least part of the stay cable.

The present invention relates to the improvement of stability against vibrations of a stay cable.

Stay cables, especially when they are part of a structural work such as a stay bridge, are generally subject to vibration phenomena which can be significant and which often result from exposure to external elements.

Well known vibration phenomena comprise in particular: whirlwind detachment, wake effect, action of turbulent wind, gallop, parametric excitation, strand respiration, as well as the rain +wind phenomenon.

The vibrations must be fought, because they impart an insecurity feeling to the users of the structural work in which said stay cables take part, but also because they are harmful for the structure and durability of the cables themselves.

The rain +wind phenomenon is now more specifically considered. Under certain rain and wind conditions, water streams on the surface of the sheath housing the strands of a stay cable. The water generally concentrates on two trickles of water (or furrows) following respectively top and bottom longitudinal lines of the cylinder formed by the sheath. The presence of those two trickles of water changes the aerodynamic behavior of the cable and the oscillatory movement of the top trickle generates aerodynamic forces which lead to instability of the stay cable. The resulting vibrations thus created may be over several meters in amplitude.

To limit the effect of the rain +wind phenomenon, it has been known to manufacture stay cables with shaped sheaths which disrupt the trickles of water. Advantageously, the profile of the sheaths must be sufficient to reduce the vibrations due to the rain +wind phenomenon but without dramatically increasing the drag effect of the wind on the cables.

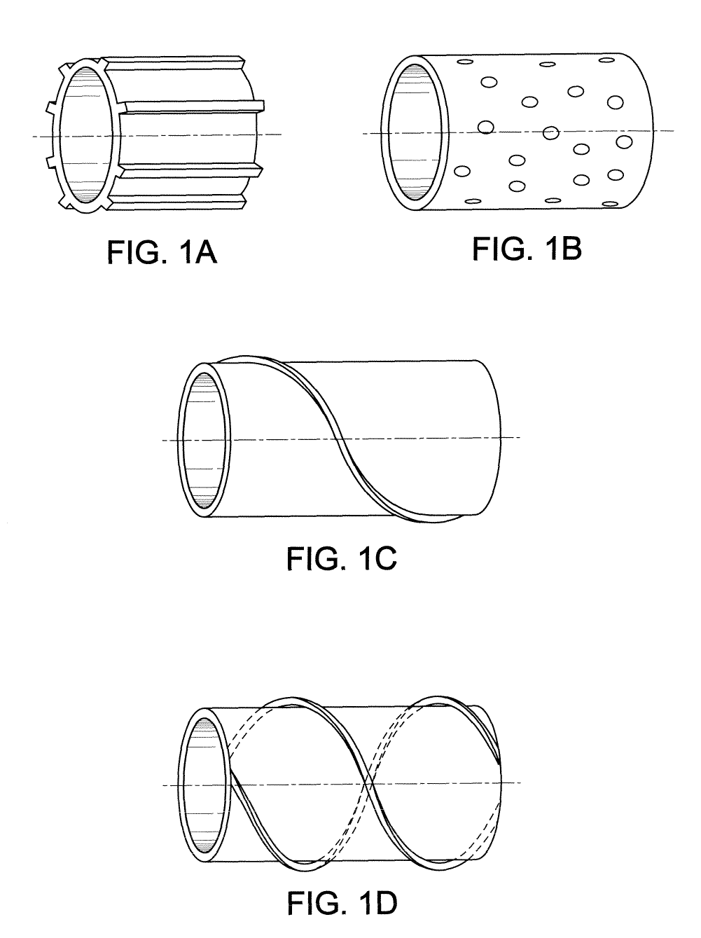

FIGS. 1A-1D show different examples of such shaped sheaths for cables. The sheath of FIG. 1A comprises deep longitudinal grooves distributed around its circumference. The sheath of FIG. 1B includes a network of small cavities randomly distributed over its outer surface. The sheaths of FIG. 1C and FIG. 1D comprise respectively a single and a double spiral relief.

In all those examples, the reliefs/cavities are integral part of the sheaths, since the latter are made with such shape from the beginning.

Such shaped sheaths for stay cables have been used recently in many structural works and have shown to be quite successful for reducing vibrations.

A problem still exists however with respect to stay cables already in use, for example as they were installed in structural works at a time when shaped sheaths were not widespread.

For those stay cables, known corrective actions of the vibration phenomena include installing massive dampers on the stay cables or installing cables transverse to the bank of stay cables (sometimes called needles). Another possibility would be to completely change the sheaths of the stay cables.

Those solutions are however complex and costly. Furthermore, the complete change of smooth sheaths to shaped sheaths would reduce the quality of the stay cables, especially in terms of watertightness.

An object of the present invention is to improve the stability against vibrations of a stay cable while limiting at least some of the drawbacks of the prior solutions mentioned above.

The invention proposes a method for improving the stability against vibrations of a stay cable comprising at least one strand housed in a substantially externally smooth sheath. According to the method, at least one wire is spirally wound round the sheath so as to be substantially in contact with said sheath along at least part of the stay cable.

Due to the at least one wire being spirally wound round the sheath, the effect of the rain +wind phenomenon. This is because the sheath, which was externally smooth initially, then has similar advantages to a shaped sheath of the prior art, with regard to the vibration phenomena, once it is wrapped with the wire(s).

The stability against vibrations of the stay cable can thus be improved, even if this stay cable was already in use, as part of a structural work for example.

Besides, winding wire(s) spirally round the sheath is relatively simple compared to installing heavy dampers or changing the whole sheath for instance. Also it does not have side effects on the quality of the stay cable, in particular in terms of watertightness, since the metal strands always remain protected by the sheath.

According to advantageous embodiments which can be combined in any conceivable manner:

two wires are spirally wound round the sheath in a double helix form, and/or

the at least one wire is spirally wound round the sheath with a pitch between 50 and 70 centimeters, and/or

the at least one wire has a thickness and/or a width in the order of a few millimeters, and/or

the at least one wire is tensioned around the sheath, and/or

the at least one wire is stuck or welded along at least part of its length with the sheath, and/or

before being wound round the sheath, the at least one wire has the form of a spiral with a diameter less than the diameter of the sheath, and, when wound round the sheath, the at least one wire comes in contact with said sheath along at least part of the stay cable by elastic deformation, and/or

the at least one wire consists at least in part of metal, and/or

the at least one wire consists at least in part of plastic, and/or

the at least one wire consists at least in part of textile fiber, and/or

the at least one wire is spirally wound round the sheath manually, by an operator moving along at least part of the stay cable, and/or

the at least one wire is spirally wound round the sheath with the aid of a mean moving autonomously along at least part of the stay cable, and/or

at least one cord extending along a longitudinal axis of the sheath is respectively connected to the at least one wire at intersection points, said at least one wire being spirally wound round the sheath along a limited part of the stay cable, and the at least one wire is then spirally wound round the sheath along at least part of the stay cable longer than said limited part of the stay cable by moving the respective at least one cord along substantially said at least part of the stay cable, and/or

the stay cable is part of a structural work when the at least one wire is spirally wound round the sheath.

The preferred features of the above aspects which are indicated by the dependent claims may be combined as appropriate, and may be combined with any of the above aspects of the invention, as would be apparent to a person skilled in the art.

FIGS. 1A-1D, already discussed, show examples of monolithic shaped sheaths for cables according to the prior art;

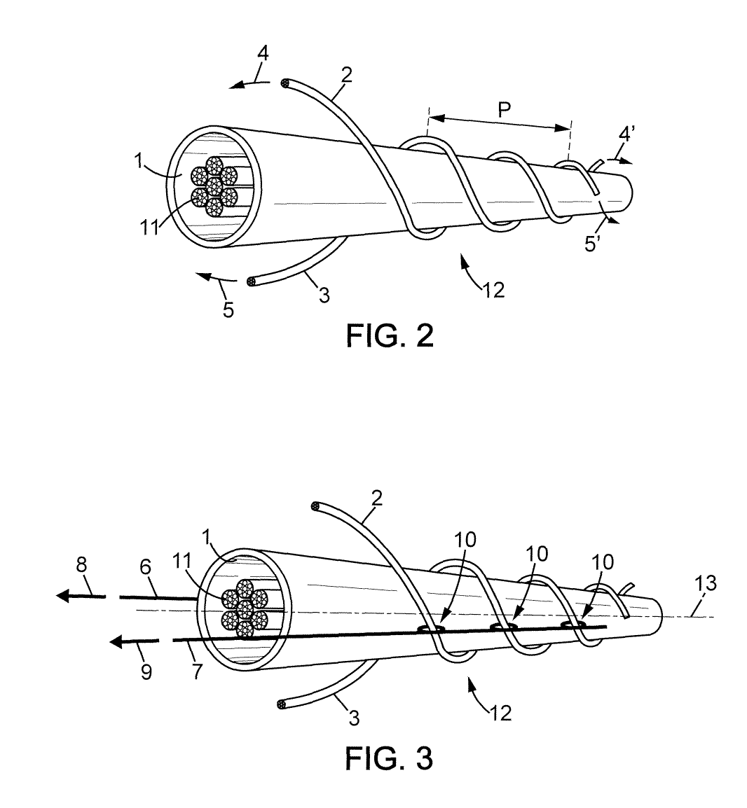

FIG. 2 schematically shows a non limitative exemplary way of spirally winding wires round an externally smooth sheath according to the invention;

FIG. 3 schematically shows another non limitative exemplary way of spirally winding wires round an externally smooth sheath according to the invention;

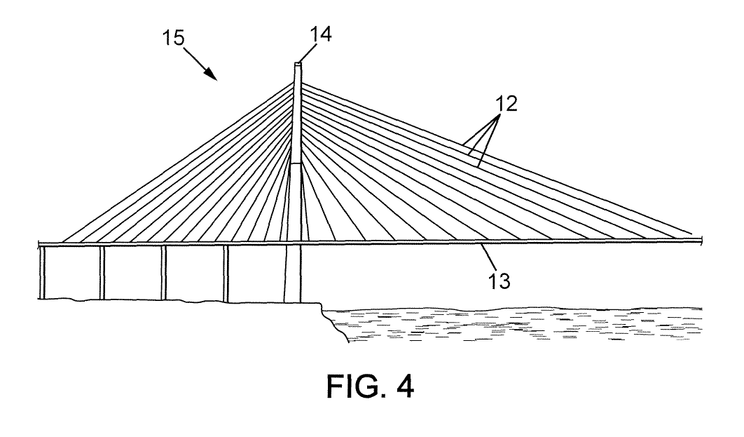

FIG. 4 schematically shows a stay bridge comprising stay cables whose stability against vibrations may be improved according to the invention.

According to the present invention, stability is improved against vibrations of a stay cable comprising at least one strand housed in a substantially externally smooth sheath, by spirally winding at least one wire round the sheath so as the wire to be in contact with said sheath along at least part of the stay cable.

Stated in another way, the profile of the sheath of the stay cable is modified by spirally wrapping it with a wire. Because of this, the outer surface of the sheath of the stay cable is then no more smooth as it used to be, but shaped.

When only one wire is wound round the sheath, the latter can have the same profile as the one shown in FIG. 1C at the final stage.

When two wires are wound round the sheath, they can advantageously be placed along the sheath according to a double helix form, like in the example of FIG. 1D.

More than two wires may also be spirally wound round the sheath.

But a major difference with the prior art mentioned in the introduction is that, here, the sheath is externally smooth initially and the wire(s) is (are) wound around it only after the sheath has been made. In the prior art, by contrast, the sheath is integrally made together with the spiral relief(s).

According to an advantageous aspect of the invention, the wire may even be wound round the sheath, while the stay cable to which the sheath belongs is already part of an existing structural work.

With reference to FIG. 4, the considered stay cable can be any one the stay cables 12 installed in the stay bridge 15 and which connect the deck 13 to the tower 14 of the stay bridge 15. Naturally, the considered stay cable could be part of any other type of structural work as well.

In the following, only one wire is considered for simplicity. Of course, every feature described in relation to this wire may apply to one or every other wires that would be additionally wound round the sheath.

A non-limiting example of arrangement would be that the wire is spirally wound round the sheath with a pitch (illustrated in FIG. 2 with the reference p) between 50 and 70 centimeters, e.g. around 60 centimeters.

The wire may also have a thickness and/or a width in the order of a few millimeters. For instance, the thickness of the wire could be around 2 millimeters while its width could be around 3 millimeters.

Tests performed by the applicant with a double helix arrangement having the above mentioned dimensions in terms of pitch, thickness and a width have revealed a reduction of the amplitude of the vibrations resulting from the rain +wind phenomenon up to a factor five. Stability of the stay cable is thus highly improved in this case.

Naturally, other dimensions and arrangements are possible as well according to the invention.

The wire can be wound round the sheath along only part or the whole length of the stay cable. It can extend continuously or discontinuously on the sheath.

In case of discontinuous positioning, the spaces provided between the successive portions of the wire are advantageously arranged so that the water flows along the stay cable are disrupted. In this way, the water cannot concentrate on trickles of water following determined lines on the sheath and the aerodynamic behavior of the stay cable is not modified, thus improving the stability against vibrations of the cable. As an example of discontinuous arrangement, the spaces provided between the successive portions of the wire may be shorter than said portions of the wire.

The contact between the wire and the sheath may ensure that water will not go therebetween. The water is thus guided by the wire with limited possibilities to follow another direction.

This contact can be more or less close depending on the way the wire interacts with the sheath.

According to a first contacting mode, the wire may be stuck or welded along its whole length with the sheath. This connection links the wire and the sheath and ensures a good level of watertightness since water is stopped by the sticking or welding. In this way, water cannot flow between the wire and the sheath and is diverted according to the wire direction.

Alternatively, the wire may be stuck or welded along only part of its length with the sheath. For example, it may be stuck or welded discontinuously with the sheath. In this case, the distance between the stuck or welded points or portions of the wire is advantageously limited so as to avoid significant amounts of water from going between the wire and the sheath in the non stuck or welded areas of the wire. Compared to the previous contacting mode, this solution has the advantage of reducing the required length of sticking or welding.

According to another contacting mode, the wire may be tensioned around the sheath. Due to the generally convex form of the transverse section of the sheath, the wire can indeed be kept in contact with the sheath by simple tensioning. To do so, the wire may be anchored at one or both of its ends and tensioned around the sheath. This solution has the advantage of not requiring any sticking or welding of the wire. The wire can also be removed and replaced easily if necessary.

Tensioning of the wire may preferably be achieved approximately at the same time the wire is wound round the sheath along part or whole of the stay cable. Due to the friction exerted between the wire and the sheath and to the contact therebetween over most of the length of the wire, if the tensioning was applied afterwards, the tension applied at a given point (e.g. an end of the wire) may indeed dissipate rapidly and affect only a short portion of the wire.

It is also possible to combine the above mentioned contacting modes. In other words, the wire may be tensioned around the sheath but also stuck or welded with the sheath continuously or discontinuously. In case of discontinuous sticking or welding, the distance between the stuck or welded points or portions of the wire can be longer than when no tensioning is carried out, because such tensioning already ensures a certain level of contact between the wire and the sheath.

Alternatively, or combination with any one of the above mentioned contacting modes, the wire, before being wound round the sheath, may have a certain rigidity and the form of a spiral with a diameter less than the diameter of the sheath. Then, when wound round the sheath, the wire comes in contact with the sheath along at least part of the stay cable by elastic deformation. The propensity of the wire to get back to its initial form with a lower diameter ensures a contacting level with the sheath similar to the case where the wire is tensioned around the sheath. A simple fastening of both ends of the wire may thus be sufficient for the wire to keep in close contact with the sheath along at least part of the stay cable.

The wire can be made of various materials. For instance, it can consist at least in part of metal (steel, stainless steel, etc.), of plastic (polyethylene, high density polyethylene, etc.) or of textile fiber. Any combination of those and/or other materials may be suitable as well. As an example, the wire may comprise a metal core covered by a plastic material.

Advantageously, the material(s) used for the wire may be chosen depending on the material(s) of the sheath round which the wire is to be spirally wound. Alternatively or in addition, the material(s) used for the wire may be chosen depending on the way the wire and the sheath will interact, for example depending on the contacting mode selected between the wire and the sheath.

When the stay cable considered is part of a stay bridge, its sheath is generally made of steel or high density polyethylene. For a steel sheath, a wire of same nature, i.e. a steel wire, may be suitable, as it could be easily welded on the sheath along the stay cable and/or at its ends. Likewise, a wire in high density polyethylene may be suitable in cooperation with a sheath also in high density polyethylene, to allow an easy and efficient welding therebetween.

As another example, a composite wire may be used together with a plastic sheath. Such composite wire may advantageously have a metal core with high resistance to traction and a plastic coating enabling good welding to the plastic sheath and protection of the metal core towards external stresses, such as corrosion.

Moreover, when using a plastic sheath for the stay cable, the above mentioned contacting modes providing to stick or weld the wire round the sheath may be privileged. Indeed, the low resistance to traction of plastic may be an obstacle to the tensioning of the wire round a plastic sheath. Besides, coiling and/or tensioning a metal wire round a plastic sheath might deteriorate the sheath due to the high hardness of metal compared to plastic.

Many ways of winding the wire round the sheath of the stay cable may be envisaged within the framework of the present invention.

According to a first example, the wire may be spirally wound round the sheath manually by an operator. Such mode of operation is illustrated in FIG. 2.

In FIG. 2, it is shown in perspective a stay cable 12 comprising a sheath 1 which houses one or several strands 11, e.g. metal strands. This sheath 1 has a cylindrical form and a smooth external surface. Other forms of the sheath may be possible as well, such as conical or truncated conical forms, or any other pipe form. Two wires 2 and 3 are spirally wound round the sheath 1, as shown by the arrows 4 and 5 respectively, so as to form a double helix extending along the stay cable. Only one end of the wires 2-3 may be wound round the sheath, the other end being fixed. But both ends of each wire 2-3 may be wound to opposite parts of the sheath as represented in FIG. 2 (see the arrows 4-5 for one end of the wires 2-3 and the arrows 4′-5′ for the other end of the wires 2-3).

In said first example, the winding operation is carried out manually, which means that an operator, moving along the stay cable, wraps the wires 2-3 around the sheath 1 according to the arrows 4-5 and/or 4′-5′. This wrapping may be accompanied by a tensioning of the wires 2-3. The operator may also continuously or discontinuously stick or weld the wires 2-3 with the sheath 1, for example as he moves along the stay cable.

This method has the drawback that is to require accessibility along the stay cable for the staff performing the winding operation. Providing such an access may be a problem, in particular when the stay cable is located high up, e.g. for a stay cable already installed in a stay bridge, as shown in FIG. 4.

Some other winding operations may avoid this drawback. As an example, the wires may be spirally wound round the sheath essentially in the same manner as the one explained above with reference to FIG. 2 (or in a different manner), except that winding the wires would not be achieved by a human operator but with the aid of a mean either drawn up or down at least part of the cable or autonomously moving along at least part of the stay cable. Such mean may include any mechanical and/or automatic mean, such as a robot moving, e.g. rotatively, along the stay cable while holding one or all of the wires. Like the operator in the previous example, this mean may also tension the wires and/or continuously or discontinuously stick or weld them, for example as it progresses along the stay cable.

Another example is illustrated in FIG. 3 in which the same references correspond to the same elements as in FIG. 2. This winding operation example makes use of one or several cords 6-7. Wires 2-3 are first spirally wound round the sheath 1 along a limited part of the stay cable, for example in the proximity of one end of the sheath 1 (on the right-hand side in the example of FIG. 3). Each cord 6-7 extends along a longitudinal axis 13 of the sheath 1 and is connected to a respective one of the wires 2-3 at some intersection points 10. Then the cords 6-7 are moved along the stay cable 12, as shown by the arrows 8-9 respectively, causing the respective wires 2-3 to progressively extend (to the left in FIG. 3) along a part of the stay cable which is longer than the initial limited part of the stay cable. Moving the cords 6-7 along the stay cable can be done by simple traction or pushing for example. The cords 6-7 may be disconnected from the wires 2-3 after they have been wound round the sheath 1, or let in place.

Naturally, many other winding operations of the wires can be envisaged within the framework of the present invention.

We claim:

1. A method for improving the stability against vibrations of a stay cable (12) comprising at least one strand (11) housed in a substantially externally smooth sheath (1), wherein at least one wire (2-3) is spirally wound round the sheath so as to be substantially in contact with said sheath along at least part of the stay cable.

2. The method as claimed in claim 1, wherein two wires (2-3) are spirally wound round the sheath (1) in a double helix form.

3. The method as claimed in claim 1 or 2, wherein the at least one wire (2-3) is spirally wound round the sheath (1) with a pitch (p) between 50 and 70 centimeters.

4. The method as claimed in any one of the foregoing claims, wherein the at least one wire (2-3) has a thickness and/or a width in the order of a few millimeters.

5. The method as claimed in any one of the foregoing claims, wherein the at least one wire (2-3) is tensioned around the sheath (1).

6. The method as claimed in any one of the foregoing claims, wherein the at least one wire (2-3) is stuck or welded along at least part of its length with the sheath (1).

7. The method as claimed in any one of the foregoing claims, wherein, before being wound round the sheath (1), the at least one wire (2-3) has the form of a spiral with a diameter less than the diameter of the sheath, and, when wound round the sheath, the at least one wire comes in contact with said sheath along at least part of the stay cable (12) by elastic deformation.

8. The method as claimed in any one of the foregoing claims, wherein the at least one wire (2-3) consists at least in part of metal.

9. The method as claimed in any one of the foregoing claims, wherein the at least one wire (2-3) consists at least in part of plastic.

10. The method as claimed in any one of the foregoing claims, wherein the at least one wire (2-3) consists at least in part of textile fiber.

11. The method as claimed in any one of the foregoing claims, wherein the at least one wire (2-3) is spirally wound round the sheath (1) manually, by an operator moving along at least part of the stay cable (12).

12. The method as claimed in any one of the foregoing claims, wherein the at least one wire (2-3) is spirally wound round the sheath (1) with the aid of a mean either drawn up or down at least part of the stay cable (12) or autonomously moving along at least part of the stay cable (12).

13. The method as claimed in any one of the foregoing claims, wherein at least one cord (6-7) extending along a longitudinal axis (13) of the sheath (1) is respectively connected to the at least one wire (2-3) at intersection points (10), said at least one wire being spirally wound round the sheath along a limited part of the stay cable (12), and wherein the at least one wire is then spirally wound round the sheath along at least part of the stay cable longer than said limited part of the stay cable by moving the respective at least one cord along substantially said at least part of the stay cable.

14. The method as claimed in any one of the foregoing claims, wherein the stay cable (12) is part of a structural work (15) when the at least one wire (2-3) is spirally wound round the sheath (1).
